(19) United States
(12) Patent Application Publication
(10) Pub. No.: US 2016/0307164 A1
(43) Pub. Date: Oct. 20, 2016

(54) LOCATION AWARE EVENT SCHEDULING

(71) Applicant: SugarCRM Inc., Cupertino, CA (US)

(72) Inventors: Nima Dehnashi, San Jose, CA (US); Vladyslav Kulchytskyy, Nashua, NH (US); Maria Zolotova, Mountain View, CA (US)

(21) Appl. No.: 14/687,905

(22) Filed: Apr. 15, 2015

(51) Int. Cl. G06Q 10/10; H04W 4/02; G06F 3/0481

(52) U.S. Cl. CPC G06Q 10/1095; G06F 3/0481; H04W 4/023

(57) ABSTRACT

Embodiments of the present invention provide a method, system and computer program product for location aware event scheduling. In an embodiment of the invention, a method for utilizing location awareness in event scheduling is provided. The method includes determining a geographic position of an end user in an organization based upon a location reported by a mobile device of the end user and computing a distance of the end user to a geographic location designated for an event in a C&S component of an enterprise data processing system. The method also includes determining based upon the computed distance and a designated time for the event whether or not the end user is able or unable to attend the event. Finally, the method includes displaying an indication through the C&S component of whether or not the end user is able to attend the event.

### BACKGROUND OF THE INVENTION

1. Field of the Invention

The present invention relates to location based services and more particularly to location based services in event scheduling.

2. Description of the Related Art

A location-based service is a software-driven service provided to data network connected mobile devices including smart phones, tablet personal computers and notebook computers. The location-based services processes a location determined for a corresponding mobile device and performs ancillary data processing based upon the determined location. The location-based service can be provided remotely from the mobile device, or the location based service can be included as part of the mobile device. In either circumstance, the location based service can be query-based and provide the end user with useful information based upon a determined location of the mobile device, or the location based service can be push-based and deliver data to the mobile device based upon the determined location.

A location based service requires different interoperable components to function. Essential amongst those components are the mobile device itself, location determining circuitry disposed in the mobile device, such as global positioning system (GPS) sensor and corresponding firmware, a computer communications network over which data pertaining to a determined location can be received by or provided from the mobile device, and an ancillary application executing in the mobile device and processing a determined location in order to transmit or receive geographically relevant data. Other components may include a content provider coupled to the mobile device and enabled to provide content responsive to a determined location for a mobile device.

Location based services typically are associated with individual marketing in which marketing messaging or is provided to each individual mobile device based upon a contemporaneous location determined for each individual mobile device. However, location based services can be of enormous benefit when applied in the enterprise setting. Of particular interest, location based services have been proven helpful in event management. In this regard, calendaring and scheduling (C&S) applications often utilize location based services to provide a map with directions to a scheduled meeting at the time of scheduling the meeting. Likewise, some enterprise travel scheduling applications utilize location based services in order to suggest different vendors proximate to a scheduled travel event, such as a nearby gas station, restaurant, rental car agency or hotel.

### BRIEF SUMMARY OF THE INVENTION

Embodiments of the present invention address deficiencies of the art in respect to the enterprise utilization of location based services and provide a novel and non-obvious method, system and computer program product for location aware event scheduling. In an embodiment of the invention, a method for utilizing location awareness in event scheduling is provided. The method includes determining a geographic position of an end user in an organization based upon a location reported by a mobile device of the end user and computing a distance of the end user to a geographic location designated for an event in a C&S component of an enterprise data processing system. The method also includes determining based upon the computed distance and a designated time for the event whether or not the end user is able or unable to attend the event. Finally, the method includes displaying an indication through the C&S component of whether or not the end user is able to attend the event.

In one aspect of the embodiment, the indication is displayed prior to scheduling the event in a user interface presented to an organizer of the event. In another aspect of the embodiment, the indication is displayed subsequent to scheduling the event but prior to a commencement of the event in a user interface presented to an organizer of the event. In yet another aspect of the embodiment, in response to a determination that the end user is unable to attend the event based upon the computed distance and the designated time of the event, it is further determined whether or not the end user contemporaneously is utilizing the mobile device so as to permit remote attendance to the event using the mobile device despite the computed distance and designated time, and if so, displaying an indication to an organizer of the event of the remote availability of the end user.

In another embodiment of the invention, an enterprise data processing system is configured for location aware event scheduling. The system includes a host computing system with one or more computers each with memory and at least one processor. The system also includes a data store coupled to the host computing system and an enterprise application executing in the memory of the host computing platform. The enterprise application provides data access to data in the data store to different end users over a computer communications network connecting the host computing system to client computers of the different end users.

Of note, a C&S component of the enterprise application provides event scheduling logic for scheduling events for the different end users. Finally, a location aware event scheduling module is coupled to the C&S component. The module includes program code enabled upon execution by a processor of a computer to determine a geographic position of an end user based upon a location reported by a mobile device of the end user, to compute a distance of the end user to a geographic location designated for an event in the C&S component, to determine based upon the computed distance and a designated time for the event whether or not the end user is able or unable to attend the event and to display an indication through the C&S component of whether or not the end user is able to attend the event.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for location aware event scheduling;

FIG. 2 is a schematic illustration of an enterprise data processing system configured for location aware event scheduling; and,

FIG. 3 is a flow chart illustrating a process for location aware event scheduling.

### DETAILED DESCRIPTION OF THE INVENTION

Embodiments of the invention provide for location aware event scheduling. In accordance with an embodiment of the invention, a set of users registered with a C&S component of an enterprise application are selected and a location for each of the users is determined. Thereafter, a distance from an event location of an event is computed for each of the end users. Ones of the end users computed to be able to attend the event are indicated as such in a user interface to the C&S component. In addition or in the alternative, ones of the end users computed to be unable to attend the event also are indicated as such in the user interface to the C&S component. Optionally, end users computed to be unable to attend the event physically due to a computed corresponding contemporaneous distance from the event location, but detected to be remotely activate on a computer are indicated as being able to attend the event remotely by computer.

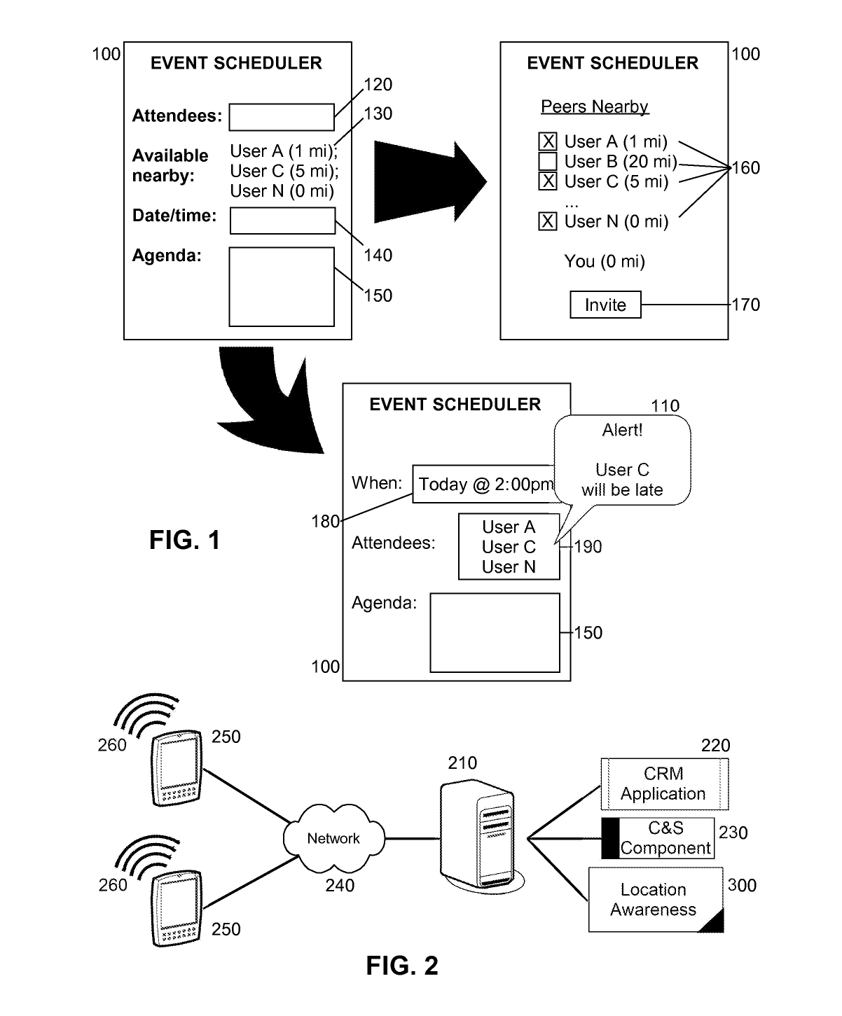

In further illustration, FIG. 1 pictorially shows a process for location aware event scheduling. As shown in FIG. 1, an event scheduler 100 can receive in the course of scheduling an event on behalf of an end user of a C&S component of an enterprise application, a designation in field 120 of one or more prospective attendees to the event, a specification in field 140 of a date and time for the event and a specified agenda in field 150 for the event. Additionally, a listing 130 can be provided of one or more other end users available for event scheduling including a corresponding contemporaneous distance from a geographic location of the event.

A separate display of the event scheduler 100 can be provided, for example in response to the activation of the field 120 for designating attendees. The separate display can include a selectable list 160 of the end users of the listing 130 also indicating a contemporaneous distance from the geographic location of the event. Different ones of the end users in the selectable list 160 can receive a selection to be invited to the event and, in response to the activation of button 170, those end users corresponding to the selected end users of the selectable list 160 receive an electronic mail inviting those end users to the event.

A further separate display of the event scheduler 100 can be provided thereafter in temporal proximity to the date and time scheduled for the event—for instance within an hour of the time scheduled for the event. The further separate display can include a field 180 indicating when the event is scheduled, a listing 190 of the end users scheduled to attend the event, and a description 150 of the agenda for the event. Of import, a geographic location of each of the end users included in the listing 190 can be determined. Thereafter, a likelihood that each of the end users will be able to attend the meeting in person as scheduled can be determined based upon the geographic location of each of the end users, and a time remaining before a commencement of the event.

The process described in connection with FIG. 1 can be implemented in an enterprise data processing system. In yet further illustration, FIG. 2 schematically shows an enterprise data processing system configured for location aware event scheduling. The system includes a host computing system 210 that includes one or more computers, each with memory and at least one processor. The host computing system 210 supports the operation of an enterprise application such as a customer relationship management (CRM) application 220 that includes a C&S component 230 utilized to schedule events for different end users of the CRM application 220. Importantly, a location awareness module 300 is coupled to the C&S component 230 and configured to receive location data from different mobile devices 250 configured with respective locating circuitry such global positioning system (GPS) circuitry.

The location awareness module 300 includes program code that is enabled upon execution in the memory of a computer such as the host computing system 210, to determine a geographic location for different ones of the mobile devices 250 communicatively coupled to the host computing system 210 over computer communications network 240 and associated with correspondingly different end users of the CRM application 220. The program code also is enabled to determine whether or not each of the end users is available to attend an event specified by the C&S application 220 based the determined geographic location of each of the end users and a time when the event has been scheduled or is intended to be scheduled.

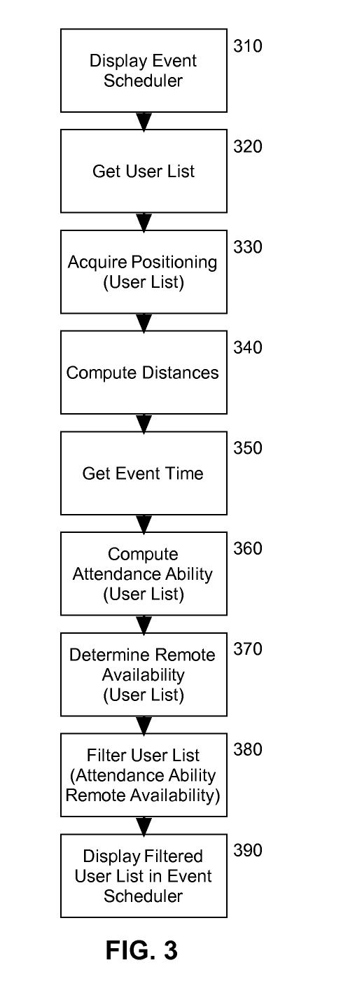

In even yet further illustration of the operation of the location awareness module 300, FIG. 3 is a flow chart illustrating a process for location aware event scheduling. Beginning in block 310, an event scheduler is displayed in a user interface of a C&S component of an enterprise application. In block 320, a user list of end users registered with the C&S component are retrieved and in block 330, a geographic position is acquired for each of the end users in the user list based upon the geographic coordinates reported by different mobile devices associated with corresponding ones of the different end users.

In block 340, a distance from a geographic location of a prospective event for each of the end users is computed and in block 350, a time desired for the prospective event is loaded into memory. Thereafter, in block 360, an availability of each end user in the list to attend in person the prospective event is computed based upon the distance of each end user to the geographic location of the prospective meeting and a time when the prospective meeting is to be scheduled. Optionally, in block 370, for each end user it is also determined whether or not the end user has indicated in the C&S application an ability to attend prospective events remotely by way of a computer instead of appearing in person.

In block 380, the user list is filtered to include only those of the end users known to be geographically proximate enough to the geographic location of the prospective event so as to be able to appear at the prospective event in person at the time when the prospective event is to occur. Optionally, the filtered list can include end users who whilst unable to attend the prospective event in person, are able to attend remotely. Thereafter, in block 390, the filtered list can be displayed in connection with the scheduling of the prospective event.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for utilizing location awareness in event scheduling comprising:
determining a geographic position of an end user in an organization based upon a location reported by a mobile device of the end user;
computing a distance of the end user to a geographic location designated for an event in a calendaring and scheduling (C&S) component of an enterprise data processing system;
determining based upon the computed distance and a designated time for the event whether or not the end user is able or unable to attend the event; and,
displaying an indication through the C&S component of whether or not the end user is able to attend the event.

2. The method of claim 1, wherein the indication is displayed prior to scheduling the event in a user interface presented to an organizer of the event.

3. The method of claim 1, wherein the indication is displayed subsequent to scheduling the event but prior to a commencement of the event in a user interface presented to an organizer of the event.

4. The method of claim 1, wherein in response to a determination that the end user is unable to attend the event based upon the computed distance and the designated time of the event, it is further determined whether or not the end user contemporaneously is utilizing the mobile device so as to permit remote attendance to the event using the mobile device despite the computed distance and designated time, and if so, displaying an indication to an organizer of the event of the remote availability of the end user.

5. An enterprise data processing system configured for location aware event scheduling, the system comprising:
a host computing system comprising one or more computers each with memory and at least one processor;
a data store coupled to the host computing system;
an enterprise application executing in the memory of the host computing platform and providing data access to data in the data store to different end users over a computer communications network connecting the host computing system to client computers of the different end users;
a calendaring and scheduling (C&S) component of the enterprise application providing event scheduling logic for scheduling events for the different end users; and,
a location aware event scheduling module coupled to the C&S component, the module comprising program code enabled upon execution by a processor of a computer to determine a geographic position of an end user based upon a location reported by a mobile device of the end user, to compute a distance of the end user to a geographic location designated for an event in the C&S component, to determine based upon the computed distance and a designated time for the event whether or not the end user is able or unable to attend the event and to display an indication through the C&S component of whether or not the end user is able to attend the event.

6. The system of claim 5, wherein the indication is displayed prior to scheduling the event in a user interface presented to an organizer of the event.

7. The system of claim 5, wherein the indication is displayed subsequent to scheduling the event but prior to a commencement of the event in a user interface presented to an organizer of the event.

8. The system of claim 5, wherein in response to a determination that the end user is unable to attend the event based upon the computed distance and the designated time of the event, it is further determined by the program code whether or not the end user contemporaneously is utilizing the mobile device so as to permit remote attendance to the event using the mobile device despite the computed distance and designated time, and if so, the program code displays an indication to an organizer of the event of the remote availability of the end user.

9. A computer program product for utilizing location awareness in event scheduling, the computer program product comprising a computer readable storage medium having program instructions embodied therewith, the program instructions executable by a device to cause the device to perform a method comprising:
determining a geographic position of an end user in an organization based upon a location reported by a mobile device of the end user;
computing a distance of the end user to a geographic location designated for an event in a calendaring and scheduling (C&S) component of an enterprise data processing system;
determining based upon the computed distance and a designated time for the event whether or not the end user is able or unable to attend the event; and,
displaying an indication through the C&S component of whether or not the end user is able to attend the event.

10. The computer program product of claim 9, wherein the indication is displayed prior to scheduling the event in a user interface presented to an organizer of the event.

11. The computer program product of claim 9, wherein the indication is displayed subsequent to scheduling the event but prior to a commencement of the event in a user interface presented to an organizer of the event.

12. The computer program product of claim 9, wherein in response to a determination that the end user is unable to attend the event based upon the computed distance and the designated time of the event, it is further determined whether or not the end user contemporaneously is utilizing the mobile device so as to permit remote attendance to the event using the mobile device despite the computed distance and designated time, and if so, displaying an indication to an organizer of the event of the remote availability of the end user.
